(19) United States
(12) Patent Application Publication
(10) Pub. No.: US 2013/0197736 A1
(43) Pub. Date: Aug. 1, 2013

(54) VEHICLE CONTROL BASED ON PERCEPTION UNCERTAINTY

(71) Applicants: Jiajun Zhu, Sunnyvale, CA (US); Dmitri A. Dolgov, Mountain View, CA (US); David I. Ferguson, San Francisco, CA (US)

(72) Inventors: Jiajun Zhu, Sunnyvale, CA (US); Dmitri A. Dolgov, Mountain View, CA (US); David I. Ferguson, San Francisco, CA (US)

(73) Assignee: Google Inc., Mountain View, CA (US)

(21) Appl. No.: 13/361,083

(22) Filed: Jan. 30, 2012

(51) Int. Cl. G05D 1/00

(52) U.S. Cl. 701/26

(57) ABSTRACT

Aspects of the disclosure relate generally to maneuvering autonomous vehicles. Specifically, the vehicle may determine the uncertainty in its perception system and use this uncertainty value to make decisions about how to maneuver the vehicle. For example, the perception system may include sensors, object type models, and object motion models, each associated with uncertainties. The sensors may be associated with uncertainties based on the sensor's range, speed, and /or shape of the sensor field. The object type models may be associated with uncertainties, for example, in whether a perceived object is of one type (such as a small car) or another type (such as a bicycle). The object motion models may also be associated with uncertainties, for example, not all objects will move exactly as they are predicted to move. These uncertainties may be used to maneuver the vehicle.

### BACKGROUND

Autonomous vehicles use various computing systems to aid in the transport of passengers from one location to another. Some autonomous vehicles may require an initial input or continuous input from an operator, such as a pilot, driver, or passenger. Other autonomous systems, for example autopilot systems, may be used only when the system has been engaged, which permits the operator to switch from a manual mode (where the operator exercises a high degree of control over the movement of the vehicle) to an autonomous mode (where the vehicle essentially drives itself) to modes that lie somewhere in between.

Such vehicles are equipped with vehicle perception systems including various types of sensors in order to detect objects in the surroundings. For example, autonomous vehicles may include lasers, sonar, radar, cameras, and other devices which scan and record data from the vehicle's surroundings. These devices in combination (and in some cases alone) may be used to identify the shape and outline objects in a roadway and safely maneuver the vehicle to avoid the identified objects.

However, these vehicle perception systems may include various limitations. These limitations are often due to different sensor characteristics. For example, camera sensors do not measure distance directly, laser sensors do not measure speed directly, radar sensors do not measure the shape of objects, etc. In addition, sensors may have limited ranges, frame-rates, noise patterns, etc. All of these limitations may result in “uncertainty” in its perception of the world.

### BRIEF SUMMARY

One aspect of the disclosure provides a method for maneuvering a vehicle. The method includes detecting an object in the vehicle's surroundings using a sensor. The sensor is associated with a sensor uncertainty. A type of the object is identified based on an object type model. The object type model is associated with an object type model uncertainty. A motion model for the object is identified based on the identified type of the object. The motion model is associated with a motion model uncertainty. A processor prepares an uncertainty driving model based on the sensor uncertainty, the object type model uncertainty, and the motion model uncertainty. The uncertainty driving model includes a strategy for maneuvering the vehicle. The vehicle is then maneuvered based on the strategy of the uncertainty driving model.

In one example, the method also includes maneuvering the vehicle according to the strategy to reduce at least one of the sensor uncertainty, the object type model uncertainty, and the motion model uncertainty. In another example, the sensor is associated with a sensor speed and a sensor field having a range and a shape, and the method also includes calculating the sensor uncertainty based on the sensor speed and the range and shape of the sensor field.

Another aspect of the disclosure provides a method of maneuvering a vehicle. The method includes storing a model of sensor measurement uncertainty for a sensor of the vehicle, storing a model of object type uncertainty for objects sensed by the sensor, storing a model of motion model uncertainty for motion models used to identify the future motion of the objects sensed by the sensor, and storing a plurality of uncertainty driving models. Each uncertainty driving model of the plurality of uncertainty driving models includes a strategy for maneuvering the vehicle. The method also includes identifying an object and a list of object attributes based on the model of sensor measurement uncertainty, the model of object type uncertainty, and the model of motion model uncertainty. Each object attribute is associated with an uncertainty value such that the list of object attributes is associated with a plurality of uncertainty values. A processor selects one of the plurality of uncertainty driving models based on at least one of the plurality of uncertainty values. The vehicle is then maneuvered based on the strategy of the selected uncertainty driving model.

In one example, maneuvering the vehicle according to the strategy in order to reduce at least one of the sensor uncertainty, the object type model uncertainty, and the motion model uncertainty. In another example, the method also includes maneuvering the vehicle according to the strategy in order to reduce the one or the uncertainty values of the plurality of uncertainty values. In another example, the sensor is associated with a sensor speed and a sensor field having a range and a shape, and the method also includes calculating the model of sensor measurement uncertainty based on the sensor speed and the range and shape of the sensor field.

Yet another aspect of the disclosure provides a system for maneuvering a vehicle. The system includes a sensor for generating sensor data about the vehicle's surroundings. The sensor is associated with a sensor uncertainty. The system also includes memory storing an object type model associated with an object type uncertainty. The memory also stores a motion model associated with a motion model uncertainty. A processor is configured to access the memory and receive the sensor data from the sensor. The processor is operable to detect an object in the vehicle's surroundings using the sensor, identify a type of the object based on the object type model and the sensor data, identify a motion model for the object based on the identified type of the object, and prepare an uncertainty driving model based on the sensor uncertainty, the object type model uncertainty, and the motion model uncertainty. The uncertainty driving model includes a strategy for maneuvering the vehicle. The method also includes maneuvering the vehicle based on the strategy of the uncertainty driving model.

In one example, the processor is also operable to maneuver the vehicle according to the strategy in order to reduce at least one of the sensor uncertainty, the object type model uncertainty, and the motion model uncertainty. In another example, the sensor is further associated with a sensor speed and a sensor field having a range and a shape, and the processor is also operable to calculate the sensor uncertainty based on the sensor speed and the range and shape of the sensor field.

A further aspect of the disclosure provides a system for maneuvering a vehicle. The system includes memory storing a model of sensor measurement uncertainty for a sensor of the vehicle, a model of object type uncertainty for objects sensed by the sensor, a model of motion model uncertainty for motion models used to identify the future motion of the objects sensed by the sensor, and a plurality of uncertainty driving models. Each uncertainty driving model of the plurality of uncertainty driving models includes a strategy for maneuvering the vehicle. The system also includes a processor coupled to the memory. The processor is operable to identify an object and a list of object attributes based on the model of sensor measurement uncertainty, the model of object type uncertainty, and the model of motion model uncertainty. Each object attribute is associated with an uncertainty value such that the list of object attributes is associated with a plurality of uncertainty values. The processor is also operable to select one of the plurality of uncertainty driving models based on at least one of the plurality of uncertainty values, and the processor is operable to maneuver the vehicle based on the strategy of the selected uncertainty driving model.

In one example, the processor is also operable to maneuver the vehicle according to the strategy in order to reduce at least one of the sensor uncertainty, the object type model uncertainty, and the motion model uncertainty. In another example, the processor is also operable to maneuver the vehicle according to the strategy in order to reduce the one or the uncertainty values of the plurality of uncertainty values. In another example, the sensor is associated with a sensor speed and a sensor field having a range and a shape, and the processor is also operable to calculate the model of sensor measurement uncertainty based on the sensor speed and the range and shape of the sensor field.

Another aspect of the disclosure provides a tangible computer-readable storage medium on which computer readable instructions of a program are stored, the instructions, when executed by a processor, cause the processor to perform a method for maneuvering a vehicle. The method includes detecting an object in the vehicle's surroundings using a sensor. The sensor is associated with a sensor uncertainty. The method also includes identifying a type of the object based on an object type model. The object type model is associated with an object type model uncertainty. The method also includes identifying a motion model for the object based on the identified type of the object. The motion model is associated with a motion model uncertainty. The method includes preparing an uncertainty driving model based on the sensor uncertainty, the object type model uncertainty, and the motion model uncertainty. The uncertainty driving model includes a strategy for maneuvering the vehicle. The method also includes maneuvering the vehicle based on the strategy of the uncertainty driving model.

In one example, the method also includes maneuvering the vehicle according to the strategy in order to reduce at least one of the sensor uncertainty, the object type model uncertainty, and the motion model uncertainty.

A further aspect of the disclosure provides a tangible computer-readable storage medium on which computer readable instructions of a program are stored, the instructions, when executed by a processor, cause the processor to perform a method for maneuvering a vehicle. The method includes storing a model of sensor measurement uncertainty for a sensor of the vehicle, storing a model of object type uncertainty for objects sensed by the sensor, storing a model of motion model uncertainty for motion models used to identify the future motion of the objects sensed by the sensor, and storing a plurality of uncertainty driving models. Each uncertainty driving model of the plurality of uncertainty driving models includes a strategy for maneuvering the vehicle. The method also includes identifying an object and a list of object attributes based on the model of sensor measurement uncertainty, the model of object type uncertainty, and the model of motion model uncertainty. Each object attribute is associated with an uncertainty value such that the list of object attributes is associated with a plurality of uncertainty values. The method also includes selecting one of the plurality of uncertainty driving models based on at least one of the plurality of uncertainty values. The method includes maneuvering the vehicle based on the strategy of the selected uncertainty driving model.

In one example, the method also includes maneuvering the vehicle according to the strategy in order to reduce at least one of the sensor uncertainty, the object type model uncertainty, and the motion model uncertainty. In another example, the method also includes maneuvering the vehicle according to the strategy in order to reduce the one or the uncertainty values of the plurality of uncertainty values.

### BRIEF DESCRIPTION OF THE DRAWINGS

FIG. 1 is a functional diagram of a system in accordance with an implementation.

FIG. 2 is an interior of an autonomous vehicle in accordance with an implementation.

FIG. 3 is an exterior of an autonomous vehicle in accordance with an implementation.

FIGS. 4A-4D are diagrams of sensor fields in accordance with an implementation.

FIG. 5 is a diagram of an intersection in accordance with an implementation.

FIG. 6 is a diagram of detailed map information of an intersection in accordance with an implementation.

FIG. 7 is another diagram of an intersection in accordance with an implementation.

FIG. 8 is a diagram of an intersection including sensor data and detailed map information in accordance with an implementation.

FIG. 9 is a diagram of example data in accordance with an implementation.

FIG. 10 is a flow diagram in accordance with an implementation.

### DETAILED DESCRIPTION

In one aspect of the disclosure, a vehicle driving along a roadway may detect an object in the vehicle's surroundings. The object may be detected using a sensor having some level of uncertainty. A type of the object may be identified based on an object type model. The object type model may be associated with an object type model uncertainty. Based on the identified object type, a motion model that predicts a future location of the object may be identified. The motion model may also be associated with a motion model uncertainty. Based on the motion model uncertainty, the object type model uncertainty, and/or the sensor uncertainty, an uncertainty driving strategy may be identified. The uncertainty driving strategy may then be used to maneuver the vehicle.

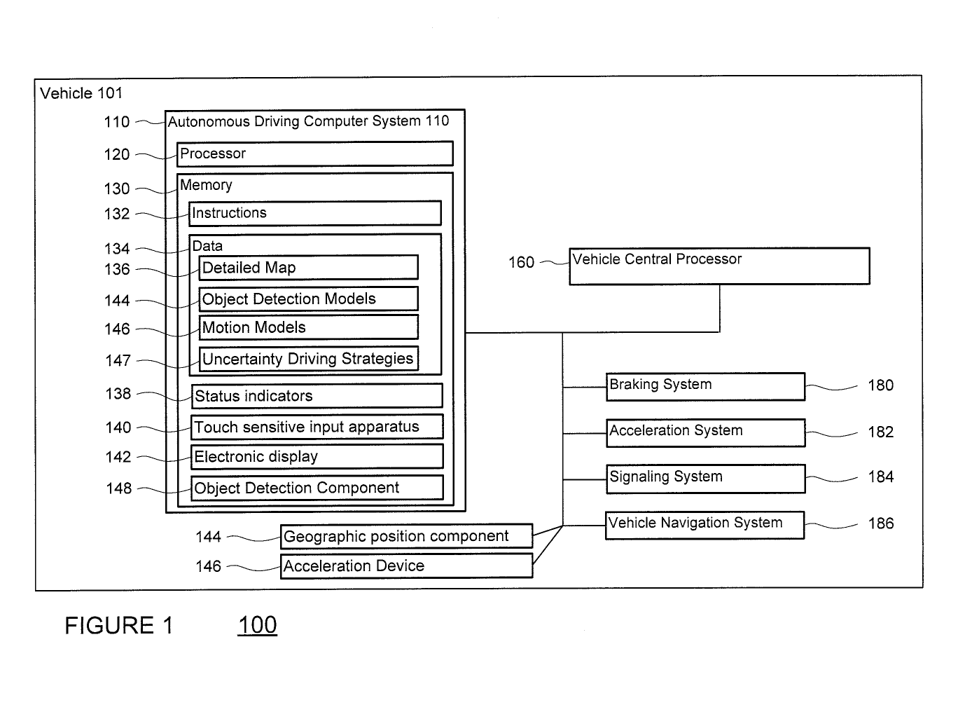

As shown in FIG. 1, an autonomous driving system 100 in accordance with one aspect of the disclosure includes a vehicle 101 with various components. While certain aspects of the disclosure are particularly useful in connection with specific types of vehicles, the vehicle may be any type of vehicle including, but not limited to, cars, trucks, motorcycles, busses, boats, airplanes, helicopters, lawnmowers, recreational vehicles, amusement park vehicles, trams, golf carts, trains, and trolleys. The vehicle may have one or more computers, such as computer 110 containing a processor 120, memory 130 and other components typically present in general purpose computers.

The memory 130 stores information accessible by processor 120, including instructions 132 and data 134 that may be executed or otherwise used by the processor 120. The memory 130 may be of any type capable of storing information accessible by the processor, including a computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. For instance, although the system and method is not limited by any particular data structure, the data may be stored in computer registers, in a relational database as a table having a plurality of different fields and records, XML documents or flat files. The data may also be formatted in any computer-readable format. By further way of example only, image data may be stored as bitmaps comprised of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

The processor 120 may be any conventional processor, such as processors from Intel Corporation or Advanced Micro Devices. Alternatively, the processor may be a dedicated device such as an ASIC. Although FIG. 1 functionally illustrates the processor, memory, and other elements of computer 110 as being within the same block, it will be understood by those of ordinary skill in the art that the processor and memory may actually comprise multiple processors and memories that may or may not be stored within the same physical housing. For example, memory may be a hard drive or other storage media located in a housing different from that of computer 110. Accordingly, references to a processor or computer will be understood to include references to a collection of processors or computers or memories that may or may not operate in parallel. Rather than using a single processor to perform the steps described herein some of the components such as steering components and deceleration components may each have their own processor that only performs calculations related to the component's specific function.

In various of the aspects described herein, the processor may be located remote from the vehicle and communicate with the vehicle wirelessly. In other aspects, some of the processes described herein are executed on a processor disposed within the vehicle and others by a remote processor, including taking the steps necessary to execute a single maneuver.

Computer 110 may all of the components normally used in connection with a computer such as a central processing unit (CPU) (e.g. processor 120), the memory 130 (e.g., RAM and internal hard drives) storing data 134 and instructions such as a web browser, an electronic display 142 (e.g., a monitor having a screen, a small LCD touch-screen or any other electrical device that is operable to display information), user input 140 (e.g., a mouse, keyboard, touch screen and/or microphone), as well as various sensors (e.g. a video camera) for gathering the explicit (e.g. a gesture) or implicit (e.g. “the person is asleep”) information about the states and desires of a person.

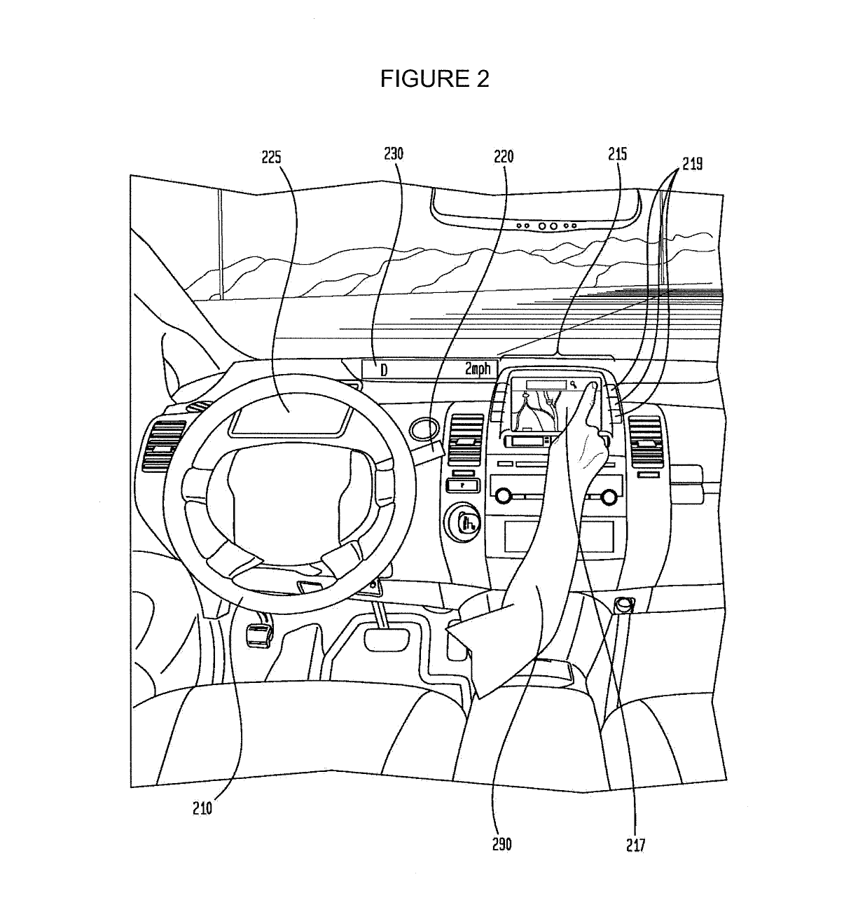

In one example, computer 110 may be an autonomous driving computing system incorporated into vehicle 101. FIG. 2 depicts an exemplary design of the interior of an autonomous vehicle. The autonomous vehicle may include all of the features of a non-autonomous vehicle, for example: a steering apparatus, such as steering wheel 210; a navigation display apparatus, such as navigation display 215; and a gear selector apparatus, such as gear shifter 220. The vehicle may also have various user input devices, such as gear shifter 220, touch screen 217, or button inputs 219, for activating or deactivating one or more autonomous driving modes and for enabling a driver or passenger 290 to provide information, such as a navigation destination, to the autonomous driving computer 110.

Vehicle 101 may also include one or more additional displays. For example, the vehicle may include a display 225 for displaying information regarding the status of the autonomous vehicle or its computer. In another example, the vehicle may include a status indicating apparatus 138 (see FIG. 1), such as status bar 230, to indicate the current status of vehicle 101. In the example of FIG. 2, status bar 230 displays “D” and “2 mph” indicating that the vehicle is presently in drive mode and is moving at 2 miles per hour. In that regard, the vehicle may display text on an electronic display, illuminate portions of vehicle 101, such as steering wheel 210, or provide various other types of indications.

The autonomous driving computing system may capable of communicating with various components of the vehicle. For example, returning to FIG. 1, computer 110 may be in communication with the vehicle's conventional central processor 160 and may send and receive information from the various systems of vehicle 101, for example the braking 180, acceleration 182, signaling 184, and navigation 186 systems in order to control the movement, speed, etc., of vehicle 101. In addition, when engaged, computer 110 may control some or all of these functions of vehicle 101 and thus be fully or merely partially autonomous. It will be understood that although various systems and computer 110 are shown within vehicle 101, these elements may be external to vehicle 101 or physically separated by large distances.

The vehicle may also include a geographic position component 144 in communication with computer 110 for determining the geographic location of the device. For example, the position component may include a GPS receiver to determine the device's latitude, longitude and/or altitude position. Other location systems such as laser-based localization systems, inertial-aided GPS, or camera-based localization may also be used to identify the location of the vehicle. The location of the vehicle may include an absolute geographical location, such as latitude, longitude, and altitude as well as relative location information, such as location relative to other cars immediately around it which can often be determined with less noise that absolute geographical location.

The vehicle may also include other features in communication with computer 110, such as an accelerometer, gyroscope or another direction/speed detection device 146 to determine the direction and speed of the vehicle or changes thereto. By way of example only, device 146 may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the user, computer 110, other computers and combinations of the foregoing.

The computer may control the direction and speed of the vehicle by controlling various components. By way of example, if the vehicle is operating in a completely autonomous mode, computer 110 may cause the vehicle to accelerate (e.g., by increasing fuel or other energy provided to the engine), decelerate (e.g., by decreasing the fuel supplied to the engine or by applying brakes) and change direction (e.g., by turning the front two wheels).

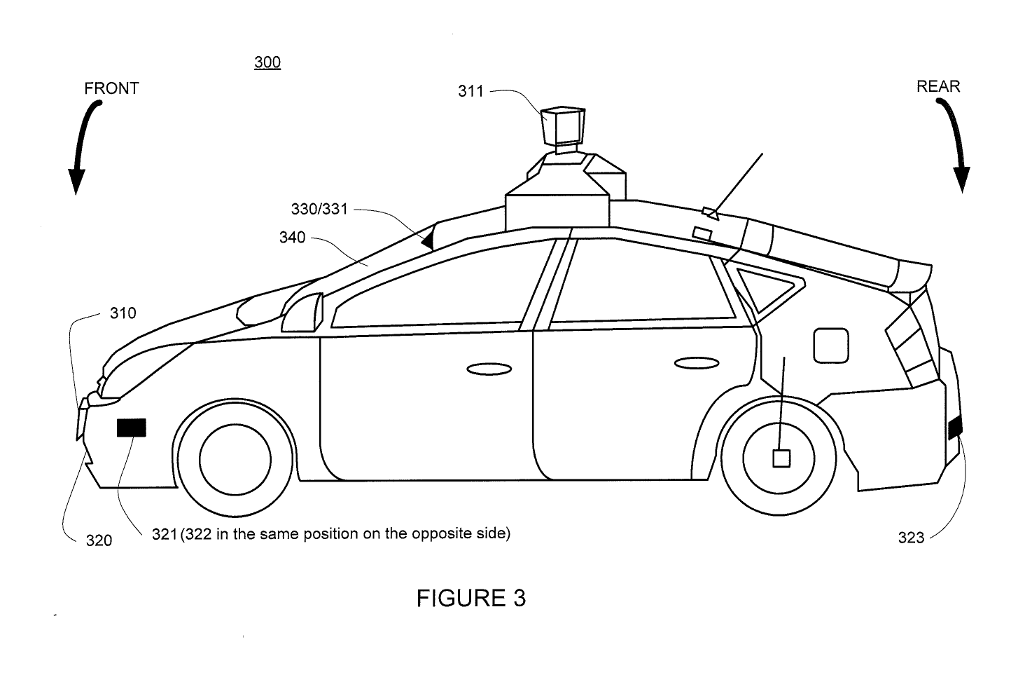

The vehicle may also include components for detecting the location, orientation, heading, etc. objects external to the vehicle such as other vehicles, obstacles in the roadway, traffic signals, signs, trees, etc. The detection system may include lasers, sonar, radar, cameras or any other detection devices which record data which may be processed by computer 110. As shown in FIG. 3, a small passenger vehicle 300 may include lasers 310 and 311, mounted on the front and top of the vehicle, respectively. Laser 310 may have a range of approximately 150 meters, a thirty degree vertical field of view, and approximately a thirty degree horizontal field of view. Laser 311 may have a range of approximately 50-80 meters, a thirty degree vertical field of view, and a 360 degree horizontal field of view. The lasers may provide the vehicle with range and intensity information which the computer may use to identify the location and distance of various objects. In one aspect, the lasers may measure the distance between the vehicle and the object surfaces facing the vehicle by spinning on its axis and changing its pitch.

The vehicle may also include various radar detection units, such as those used for adaptive cruise control systems. The radar detection units may be located on the front and back of the car as well as on either side of the front bumper. As shown in the example of FIG. 3, vehicle 300 includes radar detection units 320-323 located on the side (only one side being shown), front and rear of the vehicle. Each of these radar detection units may have a range of approximately 200 meters for an approximately 18 degree field of view as well as a range of approximately 60 meters for an approximately 56 degree field of view.

In another example, a variety of cameras may be mounted on the vehicle. The cameras may be mounted at predetermined distances so that the parallax from the images of 2 or more cameras may be used to compute the distance to various objects. As shown in FIG. 3, vehicle 300 may include 2 cameras 330-331 mounted under a windshield 340 near the rear view mirror (not shown). Camera 330 may include a range of approximately 200 meters and an approximately 30 degree horizontal field of view, while camera 331 may include a range of approximately 100 meters and an approximately 60 degree horizontal field of view.

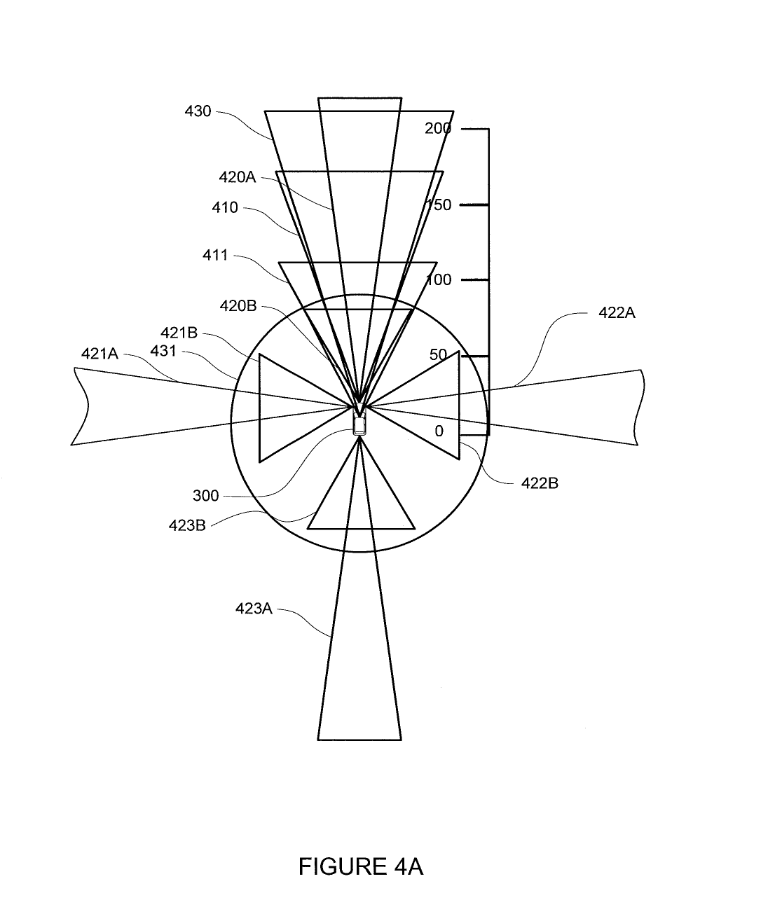

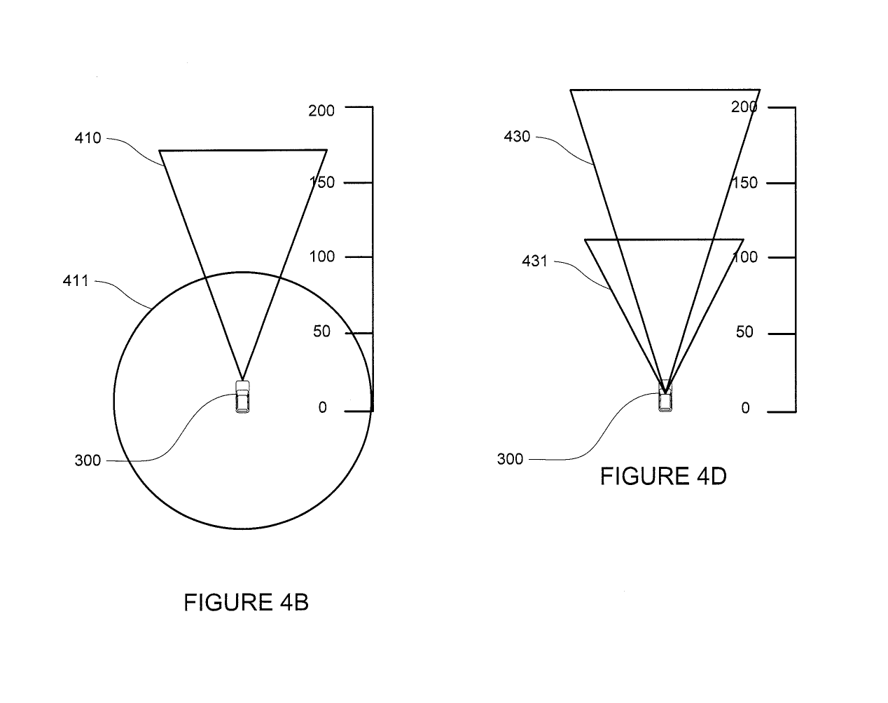

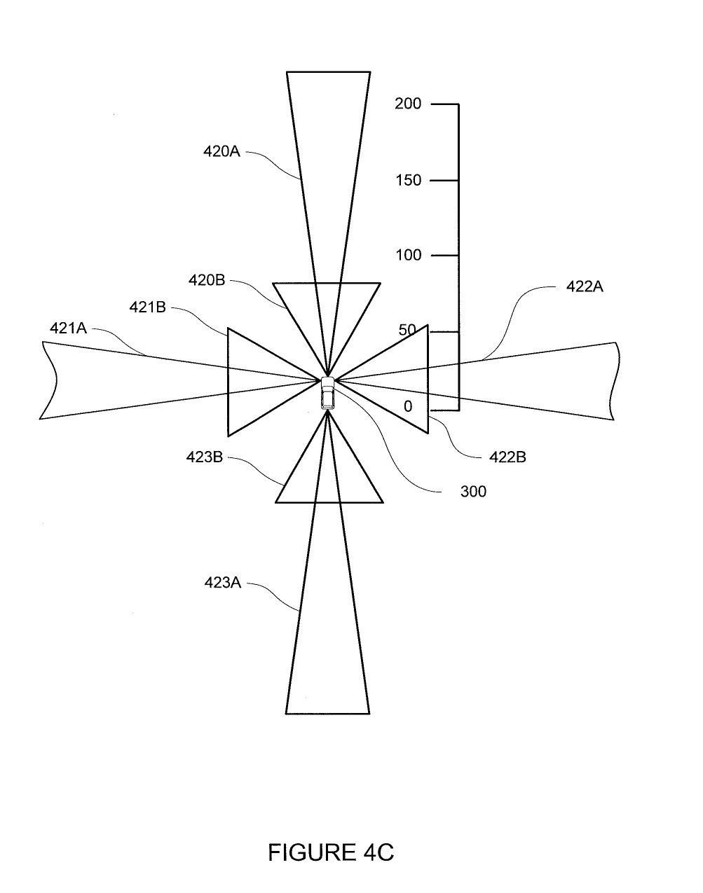

Each sensor may be associated with a particular sensor field in which the sensor may be used to detect objects. FIG. 4A is a top-down view of the approximate sensor fields of the various sensors. FIG. 4B depicts the approximate sensor fields 410 and 411 for lasers 310 and 311, respectively based on the fields of view for these sensors. For example, sensor field 410 includes an approximately 30 degree horizontal field of view for approximately 150 meters, and sensor field 411 includes a 360 degree horizontal field of view for approximately 80 meters.

FIG. 4C depicts the approximate sensor fields 420A-423B and for radar detection units 320-323, respectively, based on the fields of view for these sensors. For example, radar detection unit 320 includes sensor fields 420A and 420B. Sensor field 420A includes an approximately 18 degree horizontal field of view for approximately 200 meters, and sensor field 420B includes an approximately 56 degree horizontal field of view for approximately 80 meters. Similarly, radar detection units 321-323 include sensor fields 421A-423A and 421B-423B. Sensor fields 421A-423A include an approximately 18 degree horizontal field of view for approximately 200 meters, and sensor fields 421B-423B include an approximately 56 degree horizontal field of view for approximately 80 meters. Sensor fields 421A and 422A extend passed the edge of FIGS. 4A and 4C.

FIG. 4D depicts the approximate sensor fields 430-431 cameras 330-331, respectively, based on the fields of view for these sensors. For example, sensor field 430 of camera 330 includes a field of view of approximately 30 degrees for approximately 200 meters, and sensor field 431 of camera 430 includes a field of view of approximately 60 degrees for approximately 100 meters.

In another example, an autonomous vehicle may include sonar devices, stereo cameras, a localization camera, a laser, and/or a radar detection unit each with different fields of view. The sonar may have a horizontal field of view of approximately 60 degrees for a maximum distance of approximately 6 meters. The stereo cameras may have an overlapping region with a horizontal field of view of approximately 50 degrees, a vertical field of view of approximately 10 degrees, and a maximum distance of approximately 30 meters. The localization camera may have a horizontal field of view of approximately 75 degrees, a vertical field of view of approximately 90 degrees and a maximum distance of approximately 10 meters. The laser may have a horizontal field of view of approximately 360 degrees, a vertical field of view of approximately 30 degrees, and a maximum distance of 100 meters. The radar may have a horizontal field of view of 60 degrees for the near beam, 30 degrees for the far beam, and a maximum distance of 200 meters.

The sensor measurements may be associated with uncertainty values based on the range of a sensor, speed of the sensor detection, shape of a sensor field, the sensor resolution (such as the number of pixels in a camera or accuracy of a laser, radar, sonar, etc. over some distance). These sensors may detect objects, but there may also be some uncertainty in the type of an object, such as another vehicle, a pedestrian, a bicyclist, a stationary object, etc. For example, given two cameras, one with a higher resolution (more pixels) and another with a lower resolution (less pixels), there will be more information about an object captured by the camera with the higher resolution (assuming, of course, that the orientation, distance, lighting, etc. are the same for both cameras). This greater amount of information may lend itself to a more accurate estimate of the object's characteristics (location, speed, heading, type, etc.).

The aforementioned sensors may allow the vehicle to understand and potentially respond to its environment in order to maximize safety for passengers as well as objects or people in the environment. It will be understood that the vehicle types, number and type of sensors, the sensor locations, the sensor fields of view, and the sensors' sensor fields are merely examples. Various other configurations may also be utilized.

In addition to the sensors described above, the computer may also use input from sensors used in non-autonomous vehicles. For example, these sensors may include tire pressure sensors, engine temperature sensors, brake heat sensors, break pad status sensors, tire tread sensors, fuel sensors, oil level and quality sensors, air quality sensors (for detecting temperature, humidity, or particulates in the air), etc.

Many of these sensors provide data that is processed by the computer in real-time, that is, the sensors may continuously update their output to reflect the environment being sensed at or over a range of time, and continuously or as-demanded provide that updated output to the computer so that the computer can determine whether the vehicle's then-current direction or speed should be modified in response to the sensed environment.

In addition to processing data provided by the various sensors, the computer may rely on environmental data that was obtained at a previous point in time and is expected to persist regardless of the vehicle's presence in the environment. For example, returning to FIG. 1, data 134 may include detailed map information 135, e.g., highly detailed maps identifying the shape and elevation of roadways, lane lines, intersections, crosswalks, speed limits, traffic signals, buildings, signs, real time traffic information, or other such objects and information. For example, the map information may include explicit speed limit information associated with various roadway segments. The speed limit data may be entered manually or scanned from previously taken images of a speed limit sign using, for example, optical-character recognition. The map information may include three- dimensional terrain maps incorporating one or more of objects listed above. For example, the vehicle may determine that another car is expected to turn based on real-time data (e.g., using its sensors to determine the current GPS position of another car) and other data (e.g., comparing the GPS position with previously-stored lane-specific map data to determine whether the other car is within a turn lane).

For example, the map information may include one or more roadgraphs or graph networks of information such as roads, lanes, intersections, and the connections between these features. Each feature may be stored as graph data and may be associated with information such as a geographic location and whether or not it is linked to other related features, for example, a stop sign may be linked to a road and an intersection, etc. In some examples, the associated data may include grid-based indices of a roadgraph to allow for efficient lookup of certain roadgraph features.

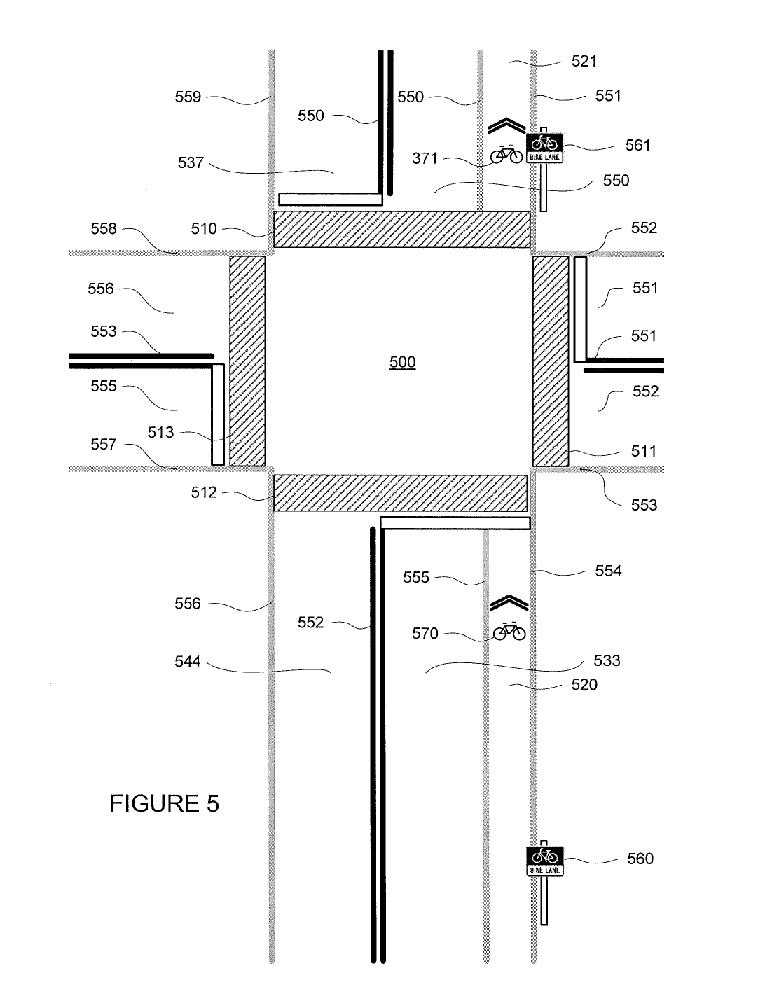

FIG. 5 depicts a birds-eye view of an exemplary intersection 500 which may be the subject of detailed map 146. The intersection may include a number of different features such as crosswalks 510-513, bicycle lanes 520-521, lanes 530-537, lane lines 550-553 and 550-559. Intersection may also include indicators such as signs 550-551 and 560-561 identifying specific areas such as bicycle lanes 520-521. Other features such as traffic signals or stop signs may also be present, but are not shown.

Although intersection 500 includes four roadways meeting perpendicular to one another, various other intersection configurations, may also be employed. It will be further understood that aspects described herein are not limited to intersections, but may be utilized in conjunction with various other traffic or roadway designs which may or may not include additional features or all of the features described with respect to intersection 500.

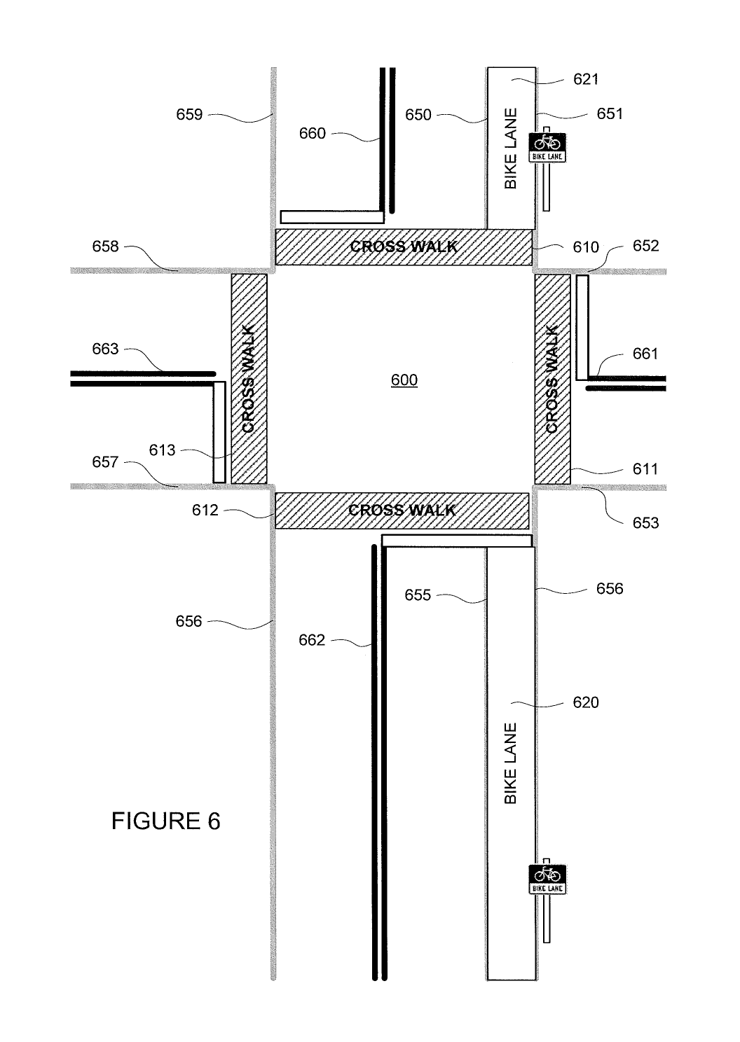

Data about the intersection (or other portions of the roadway) may be collected, for example, by driving a vehicle equipped various sensors (such as those described above). The data may be processed in order to generate the detailed map information describing the roadway. For example, as shown in FIG. 6, based on laser, geographic location, and other information collected while driving a vehicle through intersection 500, a roadgraph 600 of the intersection may be generated. Similar to intersection 500, roadgraph 600 may include various features such as lanes 630-637, lane lines 640-643 and 650-659. Each of these features may be associated with geographic location information identifying where these objects may be located in the real world (for example in intersection 500).

Again, although the detailed map information is depicted herein as an image-based map, the map information need not be entirely image based (for example, raster). For example, the detailed map information may include one or more roadgraphs or graph networks of information such as roads, lanes, intersections, and the connections between these features. Each feature may be stored as graph data and may be associated with information such as a geographic location and whether or not it is linked to other related features, for example, a stop sign may be linked to a road and an intersection, etc. In some examples, the associated data may include grid-based indices of a roadgraph to allow for efficient lookup of certain roadgraph features.

As noted above, the vehicle may use its perception system to detect and identify objects in the vehicle's surroundings. In order to do so, the vehicle's autonomous driving computer may access various object detection models 136. The models may include object type models or machine learning classifiers that output a possible object type and corresponding possibilities. In an example model, an object's type may be identified based on its location with respect to a roadway, its speed, its size, its comparison to sensor data collected by other pre-identified object (such as by image matching), etc. For example, given an object that is perceived to be about 14 inches wide, 5 feet tall, and 8 inches wide, an object type model may output information indicating that the object is 99% likely to be a pedestrian, 0.5% likely to be a bicyclist and 0.5% likely to be a vehicle. Once an object is perceived, the object type model may be used to identify the type of the perceived object.

The models may also include motion models 137 used to estimate the future motion or behavior of the identified objects. These models may be generated based on various assumptions or from data collected by sensors of a plurality of vehicles overtime and/or based on assumptions defined by an administrator. For example, by observing behaviors of passenger vehicles at the same or similar locations over time, a model of predictive motion of similar passenger vehicles may be generated. A simple example of such a motion model may include behavior predicting that a vehicle traveling North at feet per second will be 2 feet north of its previous location after 1 second. In another example, a motion model may require that objects such as road signs are stationary relative to a moving vehicle. Similarly, the motion models may demonstrate differences between different types of objects, for example, a small vehicle may maneuver itself differently from a pedestrian or a bicycle.

The motion models may also be associated with uncertainties. For example, the movements of vehicles may be easier to predict than the movements of pedestrians or bicyclists. Thus, the prediction of where a vehicle will be in 1 second may be more accurate or associated with less uncertainty than the prediction of where the pedestrian or bicyclist will be. In addition, as the motion model is identified based on the output of the object type model, any uncertainty in this model may also be incorporated into the motion model.

Data 134 may also include uncertainty driving strategies 147. The uncertainty driving models may define how to maneuver a vehicle based on the type of uncertainties associated with an object. Examples of these models are discussed in more detail below.

In addition to the operations described above and illustrated in the figures, various operations will now be described. It should be understood that the following operations do not have to be performed in the precise order described below. Rather, various steps can be handled in a different order or simultaneously, and steps may also be added or omitted.

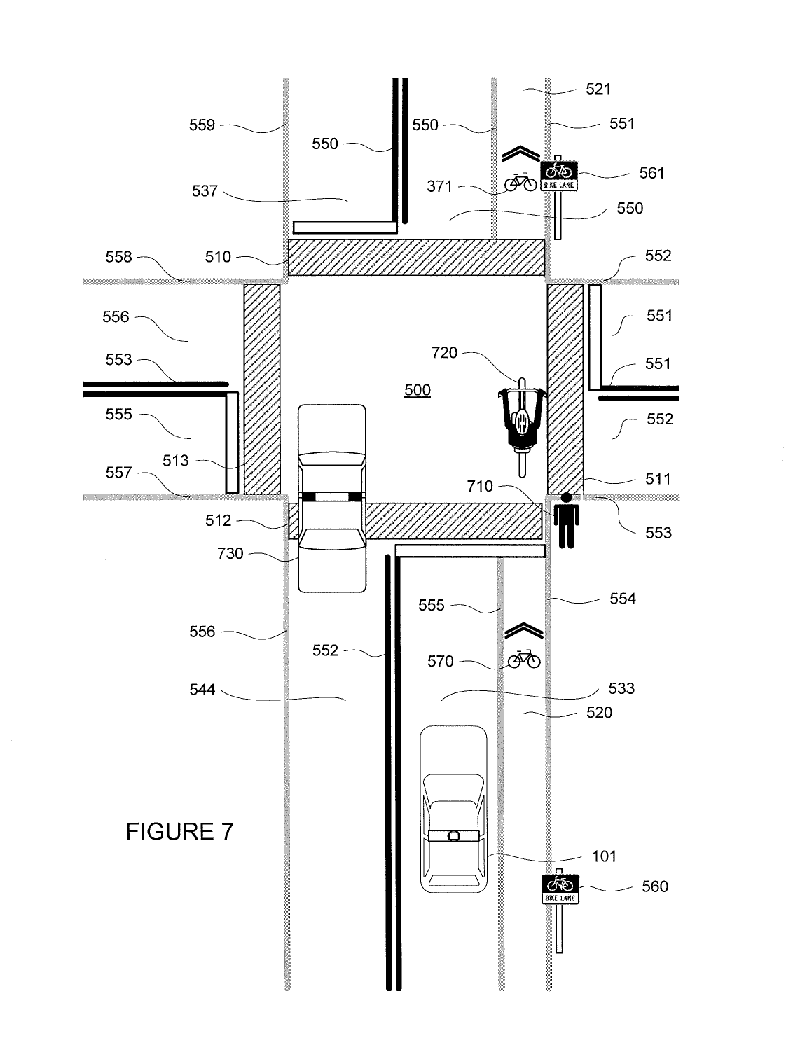

As noted above, an autonomous vehicle may drive along a roadway collecting and processing sensor data regarding the vehicle's surroundings. The vehicle may be driving itself along a roadway in a completely autonomous mode (where the vehicle does not require continuous input from a person) or in a semi-autonomous mode (where a person controls some aspects of the vehicle such as steering, braking, acceleration, etc.). As shown in FIG. 7, another bird-eye view of intersection 500, vehicle 101 approaches the intersection, various objects such as pedestrian 710, bicyclist 720, and car 730 may come into the fields of view of the vehicle's sensors. Thus, the vehicle may collect data about each of these objects.

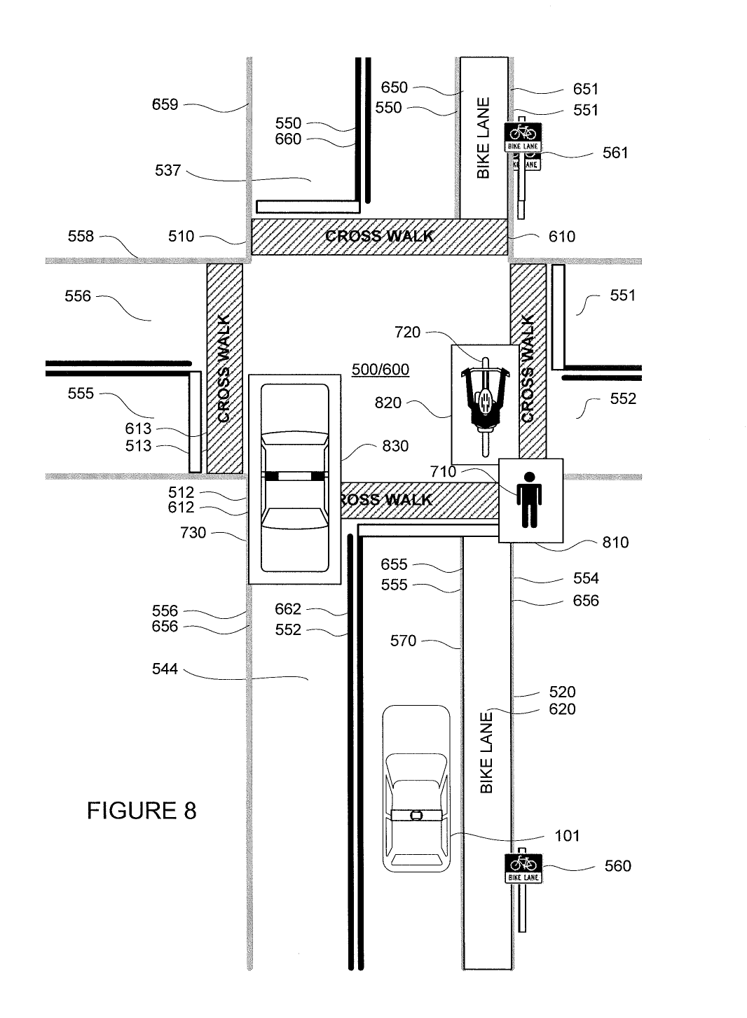

The sensor data may be processed to identify areas of the roadway occupied by objects. For example, FIG. 8 depicts intersection 500 with the detailed map information 600. Vehicle 101 processes the information received from the sensors and identifies approximate locations, headings, and speeds of objects 710, 720, and 730.

The data associated with the detected objects may also be processed using the object type models. Once the object type is determined, a motion model may also be identified. As described above, the output of the processing of the sensor data and the models are sets of information describing the aspects of the detected objects. In one example, the objects may be associated with a list of parameters describing the object type, location, heading, speed, and an estimated location of the object after some short period of time has passed. The object type may be the output of the object type models. The object's location heading and speed may be determined from the sensor data. The objects estimated location after some short period of time has passed may be the output of the motion model associated with the most likely object type. As noted above, each of these parameters may be associated with uncertainty values.

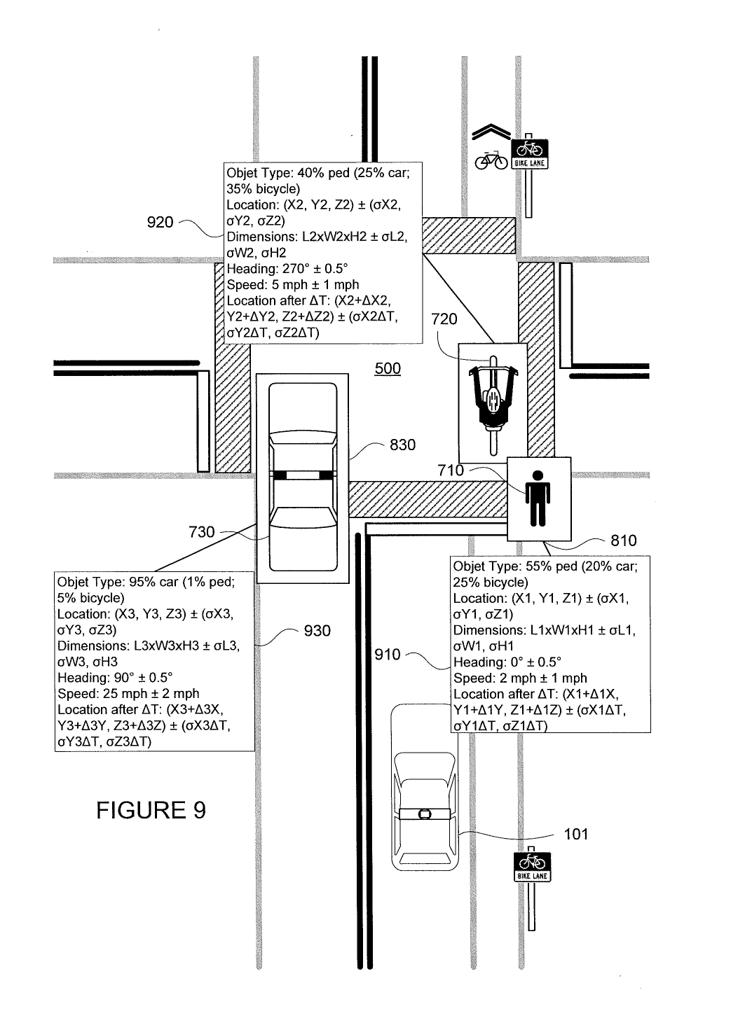

For example, as shown in FIG. 9, each of objects 810, 820, and 830 are associated with parameter data 910, 920, and 930, respectively. Specifically, parameter data 910 describing the estimated parameters of object 810 (in actuality pedestrian 710), includes an object type of pedestrian to a 55% certainty. According to the object type models, object 810 is also 20% likely to be a car and 25% likely to be a bicycle. The parameter data 910 also includes a geographic location estimate (X1, Y1, Z1), a dimension estimate (L1×W1×H1), a heading estimate (0°), and a speed estimate (2 mph). In addition, as determined from the accuracy, arrangement, and features of the sensors, the location, heading and speed estimates are also associated with uncertainty values: (σX1, σY1, σZ1), ±(σL1, σW1, σH1)±0.5°, ±1 mph, respectively. The parameter data 910 also includes an estimate of the geographic location of the object after some period of time, ΔT, has passed: (X1+Δ1X, Y1+Δ1Y, Z1+Δ1Z). This estimation is also associated with an uncertainty value: ±(σX1ΔT, σY1ΔT, σZ1ΔT).

Similarly, parameter data 920 describing the estimated parameters of object 820 (in actuality bicyclist 720), includes an object type of pedestrian to a 40% certainty. According to the object type models, object 820 is also 25% likely to be a car and 35% likely to be a bicycle. The parameter data 920 also includes a geographic location estimate (X2, Y2, Z2), a dimension estimate (L2×W2×H2), a heading estimate (270°), and a speed estimate (5 mph). In addition, as determined from the accuracy, arrangement, and features of the sensors, the location, heading and speed estimates are also associated with uncertainty values: (σX2, σY2, σZ2), ±(σL2, σW2, σH2)±0.5°, ±1 mph, respectively. The parameter data 920 also includes an estimate of the geographic location of the object after some period of time, ΔT, has passed: (X2+Δ2X, Y2+Δ2Y, Z2+Δ2Z). This estimation is also associated with an uncertainty value: ±(σX2ΔT, σY2ΔT, σZ2ΔT).

Parameter data 930 describing the estimated parameters of object 830 (in actuality bicyclist 730), includes an object type of car to a 40% certainty. According to the object type models, object 830 is 1% likely to be a pedestrian and 1% likely to be a bicycle. The parameter data 930 also includes a geographic location estimate (X3, Y3, Z3), a dimension estimate (L3×W3×H3), a heading estimate (390°), and a speed estimate (25 mph). In addition, as determined from the accuracy, arrangement, and features of the sensors, the location, heading and speed estimates are also associated with uncertainty values: (σX3, σY3, σZ3), ±(σL3, σW3, σH3)±0.5°, ±2 mph, respectively. The parameter data 930 also includes an estimate of the geographic location of the object after some period of time, ΔT, has passed: (X3+Δ3X, Y3+Δ3Y, Z3+Δ3Z). This estimation is also associated with an uncertainty value: ±(σX3ΔT, σY3ΔT, σZ3ΔT).

The parameter data of FIG. 9 is merely one example of a list of such data. Various other scales may also be used as well as different ways of expressing the parameters. For example, an object's location may be identified as a set of data points that also imply the dimensions of the object. In another example, and objects dimensions may be defined by the geographic locations of the object's outer boundaries or of a bounding box which approximates the location of the object. In still another example, rather than identifying an object's location using a global positioning coordinate system, alternatively or in addition to this, an object's distance and angle from some point on the vehicle may be used to identify the location of the object.

The parameter data may be used to select an uncertainty control strategy. For example, object 810 is associated with on object type that is 55% likely to be a pedestrian, 25% likely to be a bicycle, and 20% likely to be a car. The relatively high uncertainty may be due to the fact that vehicle 101 has only a rough estimate of the length dimension (L1±σL1) of object 810. In order to reduce the uncertainty in the object type, vehicle 101 may maneuver itself along side of object 810 such that the vehicle's sensors may observe the length of the object more clearly. This may reduce the error in the length dimension for object 810 and allow the vehicle to make a more accurate determination of the object type.

In another example, object 820 is associated with an object type that is 40% likely to be a pedestrian, 35% likely to be a bicycle, and 25% likely to be a car. In this example, object 810's location, dimensions, and location after some period of time has passed may all be associated with relatively high uncertainties as object 810 may partially obstruct the vehicle's sensor fields. In order to reduce these uncertainties, vehicle 101 may maneuver itself in order to better observe object 820, such as by driving around object 810. This may reduce the uncertainties associated with the aforementioned parameters and allow the vehicle to make a more accurate determination of the object type.

In still a further example, object 830 may be associated with an object type that is 98% likely to be a car. In this example, as the object is highly likely to be a car, vehicle 101 may continue to maneuver itself to avoid the car, for example, by staying in vehicle 101's lane.

In addition to the examples above, the uncertainty control strategies may allow vehicle 101 to maneuver itself more efficiently. For example, an object in the same lane as vehicle 101 and in front of vehicle 101 may begin to slow itself down. If there is a high degree of uncertainty as to whether the object is actually slowing down (for example a high degree of uncertainty in where the object is likely to be after a short period of time has passed), vehicle 101 may wait before beginning to slow itself down until the uncertainty associated with the object has been reduced.

In other words, although vehicle 101 may use the sensors to detect that another object is changing its speed, vehicle 101 may wait until the uncertainty associated with the speed (or change in speed) of the object has been reduced before taking any particular action (such as decelerating or accelerating vehicle 101).

In another example, if an object in the same lane as vehicle 101 and in front of vehicle 101 is predicted to leave a lane (is likely to be located in another lane after a short period time has passed) to a relatively high degree of certainty, vehicle 101 may begin to speed up in anticipation of having additional space between vehicle 101 and the other object. In yet another example, if an object in front of vehicle 101 is predicted to be moving into the same lane as vehicle 101 with a relatively high degree of uncertainty, vehicle 101 may wait until the uncertainty has reduced to some threshold level before slowing down to increase the distance between the object and vehicle 101. This may result in a somewhat more aggressive driving style, but may also increase the efficiency of the vehicle by reducing the amount of unnecessary braking or accelerating. In addition, this type of control strategies may appeal to users that are comfortable with a less passive driving style.

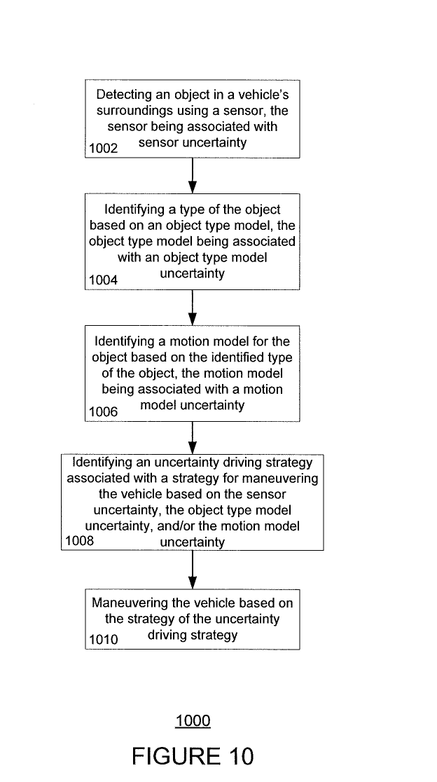

FIG. 10 depicts an example flow diagram 1000 of some of the features described above. In this example, an autonomous vehicle driving along a roadway detects an object in the vehicle's surroundings at block 1002. The object is detected using a sensor (such as those described above) associated with a sensor uncertainty. A type of the object is identified based on an object type model at block 1004. The object type model is associated with an object type model uncertainty. Based on the identified object type, a motion model, that predicts a future location of the object, is identified at block 1006. The motion model is associated with a motion model uncertainty. Based on the motion model uncertainty, the object type model uncertainty, and/or the sensor uncertainty, an uncertainty driving strategy is identified at block 1008. The uncertainty driving strategy is then used to maneuver the vehicle at block 1010.

As these and other variations and combinations of the features discussed above can be utilized without departing from the subject matter as defined by the claims, the foregoing description of exemplary implementations should be taken by way of illustration rather than by way of limitation of the subject matter as defined by the claims. It will also be understood that the provision of the examples described herein (as well as clauses phrased as “such as,” “e.g.”, “including” and the like) should not be interpreted as limiting the claimed subject matter to the specific examples; rather, the examples are intended to illustrate only some of many possible aspects.

1. A method for maneuvering a vehicle, the method comprising:
detecting an object in the vehicle's surroundings using a sensor, the sensor being associated with a sensor uncertainty;
identifying a type of the object based on an object type model, the object type model being associated with an object type model uncertainty;
identifying a motion model for the object based on the identified type of the object, the motion model being associated with a motion model uncertainty;
preparing, by a processor, an uncertainty driving model based on the sensor uncertainty, the object type model uncertainty, and the motion model uncertainty, wherein the uncertainty driving model includes a strategy for maneuvering the vehicle; and
maneuvering the vehicle based on the strategy of the uncertainty driving model.

2. The method of claim 1, further comprising maneuvering the vehicle according to the strategy to reduce at least one of the sensor uncertainty, the object type model uncertainty, and the motion model uncertainty.

3. The method of claim 1, wherein the sensor is associated with a sensor speed and a sensor field having a range and a shape, and wherein the method further comprises calculating the sensor uncertainty based on the sensor speed and the range and shape of the sensor field.

4. A method of maneuvering a vehicle, the method comprising:
storing a model of sensor measurement uncertainty for a sensor of the vehicle;
storing a model of object type uncertainty for objects sensed by the sensor;
storing a model of motion model uncertainty for motion models used to identify the future motion of the objects sensed by the sensor;
storing a plurality of uncertainty driving models, each uncertainty driving model of the plurality of uncertainty driving models including a strategy for maneuvering the vehicle;
identifying an object and a list of object attributes based on the model of sensor measurement uncertainty, the model of object type uncertainty, and the model of motion model uncertainty, wherein each object attribute is associated with a uncertainty value such that the list of object attributes is associated with a plurality of uncertainty values;
selecting, by a processor, one of the plurality of uncertainty driving models based on at least one of the plurality of uncertainty values; and
maneuvering the vehicle based on the strategy of the selected uncertainty driving model.

5. The method of claim 4, further comprising maneuvering the vehicle according to the strategy in order to reduce at least one of the sensor uncertainty, the object type model uncertainty, and the motion model uncertainty.

6. The method of claim 4, further comprising maneuvering the vehicle according to the strategy in order to reduce the one or the uncertainty values of the plurality of uncertainty values.

7. The method of claim 4, wherein the sensor is associated with a sensor speed and a sensor field having a range and a shape, and the method further comprises calculating the model of sensor measurement uncertainty based on the sensor speed and the range and shape of the sensor field.

8. A system for maneuvering a vehicle, the system comprising:
a sensor for generating sensor data about the vehicle's surroundings, the sensor being associated with a sensor uncertainty;
memory storing an object type model associated with an object type uncertainty, the memory further storing a motion model associated with a motion model uncertainty;
a processor configured to access the memory and receive the sensor data from the sensor, the processor being operable to:
detect an object in the vehicle's surroundings using the sensor;
identify a type of the object based on the object type model and the sensor data;
identify a motion model for the object based on the identified type of the object;
prepare an uncertainty driving model based on the sensor uncertainty, the object type model uncertainty, and the motion model uncertainty, wherein the uncertainty driving model includes a strategy for maneuvering the vehicle; and
maneuver the vehicle based on the strategy of the uncertainty driving model.

9. The system of claim 8, wherein the processor is further operable to maneuver the vehicle according to the strategy in order to reduce at least one of the sensor uncertainty, the object type model uncertainty, and the motion model uncertainty.

10. The system of claim 8, wherein the sensor is further associated with a sensor speed and a sensor field having a range and a shape, and wherein the processor is further operable to calculate the sensor uncertainty based on the sensor speed and the range and shape of the sensor field.

11. A system for maneuvering a vehicle, the system comprising:
memory storing a model of sensor measurement uncertainty for a sensor of the vehicle, a model of object type uncertainty for objects sensed by the sensor, a model of motion model uncertainty for motion models used to identify the future motion of the objects sensed by the sensor, and a plurality of uncertainty driving models, each uncertainty driving model of the plurality of uncertainty driving models including a strategy for maneuvering the vehicle; and
a processor coupled to the memory and operable to:
identify an object and a list of object attributes based on the model of sensor measurement uncertainty, the model of object type uncertainty, and the model of motion model uncertainty, wherein each object attribute is associated with a uncertainty value such that the list of object attributes is associated with a plurality of uncertainty values;
select one of the plurality of uncertainty driving models based on at least one of the plurality of uncertainty values; and
maneuver the vehicle based on the strategy of the selected uncertainty driving model.

12. The system of claim 11, wherein the processor is further operable to maneuver the vehicle according to the strategy in order to reduce at least one of the sensor uncertainty, the object type model uncertainty, and the motion model uncertainty.

13. The system of claim 11, wherein the processor is further operable to maneuver the vehicle according to the strategy in order to reduce the one or the uncertainty values of the plurality of uncertainty values.

14. The system of claim 11, wherein the sensor is associated with a sensor speed and a sensor field having a range and a shape, and wherein the processor is further operable to calculate the model of sensor measurement uncertainty based on the sensor speed and the range and shape of the sensor field.

15. A tangible computer-readable storage medium on which computer readable instructions of a program are stored, the instructions, when executed by a processor, cause the processor to perform a method for maneuvering a vehicle, the method comprising:
detecting an object in the vehicle's surroundings using a sensor, the sensor being associated with a sensor uncertainty;
identifying a type of the object based on an object type model, the object type model being associated with an object type model uncertainty;
identifying a motion model for the object based on the identified type of the object, the motion model being associated with a motion model uncertainty;
preparing, by a processor, an uncertainty driving model based on the sensor uncertainty, the object type model uncertainty, and the motion model uncertainty, wherein the uncertainty driving model includes a strategy for maneuvering the vehicle; and
maneuvering the vehicle based on the strategy of the uncertainty driving model.

16. The tangible computer-readable storage medium of claim 15, wherein the method further comprises maneuvering the vehicle according to the strategy in order to reduce at least one of the sensor uncertainty, the object type model uncertainty, and the motion model uncertainty.

17. A tangible computer-readable storage medium on which computer readable instructions of a program are stored, the instructions, when executed by a processor, cause the processor to perform a method for maneuvering a vehicle, the method comprising:
storing a model of sensor measurement uncertainty for a sensor of the vehicle;
storing a model of object type uncertainty for objects sensed by the sensor;
storing a model of motion model uncertainty for motion models used to identify the future motion of the objects sensed by the sensor;
storing a plurality of uncertainty driving models, each uncertainty driving model of the plurality of uncertainty driving models including a strategy for maneuvering the vehicle;
identifying an object and a list of object attributes based on the model of sensor measurement uncertainty, the model of object type uncertainty, and the model of motion model uncertainty, wherein each object attribute is associated with a uncertainty value such that the list of object attributes is associated with a plurality of uncertainty values;
selecting one of the plurality of uncertainty driving models based on at least one of the plurality of uncertainty values; and
maneuvering the vehicle based on the strategy of the selected uncertainty driving model.

18. The tangible computer-readable storage medium of claim 17, wherein the method further comprises maneuvering the vehicle according to the strategy in order to reduce at least one of the sensor uncertainty, the object type model uncertainty, and the motion model uncertainty.

19. The tangible computer-readable storage medium of claim 17, wherein the method further comprises maneuvering the vehicle according to the strategy in order to reduce the one or the uncertainty values of the plurality of uncertainty values.
